(19) United States
(12) Patent Application Publication
(10) Pub. No.: US 2026/0228447 A1
(43) Pub. Date: Aug. 6, 2026

(54) System And Method for Edge-Based Multimodal Data Processing and Control Using a Lightweight Language Model and Agent-Orchestration

(71) Applicant: Xinxin shan, Surrey (CA)

(72) Inventor: Xinxin shan, Surrey (CA)

(73) Assignee: LED Smart Inc, Surrey, BC (CA)

(21) Appl. No.: 19/045,252

(22) Filed: Feb. 4, 2025

(51) Int. Cl. G06F 40/40; G06F 16/2452

(52) U.S. Cl. CPC G06F 40/40; G06F 16/24522

(57) ABSTRACT

A system and method for edge-based multimodal data processing and control featuring a local data processing layer, specialized AI modules, a lightweight language model (LLM), and an agent for orchestrating workflows. Multimodal sensor data (camera, audio, numerical) are collected over various protocols (BLE Mesh, Thread, Wi-Fi, PLC), parsed locally, and processed in near offline or offline mode. The agent invokes computer vision, OCR, predictive maintenance tools, or the LLM as required, and interfaces with industrial control systems for real-time actuation and alarms. By integrating advanced AI with industrial PLC/SCADA hardware, the invention reduces cloud dependence and improves fault tolerance in industrial or building management applications.

### CROSS-REFERENCE TO RELATED APPLICATIONS

### US Patent Documents

U.S. Pat. No. 10,230,798 B2 March/2019 Doraiswamy et al

U.S. Pat. No. 11,580,428 B2 February/2023 Guim Bernat et al.

US 20190129405 A1 May/2019 Cella et al.

### BACKGROUND OF THE INVENTION

Conventional industrial control systems (ICS) rely on supervisory control and data acquisition (SCADA) or programmable logic controllers (PLCs) for automated control and monitoring. These systems often lack advanced on-site data processing and typically forward large volumes of sensor data to cloud-based servers for analytics, resulting in potential latency, connectivity challenges, and cybersecurity concerns. Therefore, there is a need for a real-time, robust, and secure edge-based solution capable of processing multimodal data and executing AI-driven control logic in an offline or near-offline setting.

### SUMMARY OF THE INVENTION

The present invention provides a system and method for edge-based multimodal data processing and control that addresses the shortcomings of existing solutions. In one embodiment, the invention enables the collection of sensor and user-interface data from various sources, including cameras, microphones, and mobile applications, transmitted over multiple network protocols such as Bluetooth® Low Energy (BLE) Mesh, Thread, Wi-Fi, and Power Line Communication (PLC). An on-site data processing layer performs parsing, normalization, buffering, and data alignment in a lightweight database or message queue, thereby reducing reliance on external servers. A quantized or otherwise optimized lightweight language model (LLM), for example a small-scale variant of LLaMA or similar, is incorporated to provide text generation, reasoning, and multimodal input analysis directly at the edge. An Agent software module orchestrates this workflow by automatically invoking specialized AI tools—such as computer vision, optical character recognition (OCR), and predictive maintenance routines—based on scenario identifiers, user requests, or fault triggers. The system subsequently delivers results to industrial control equipment and human-machine interfaces (HMI), including programmable logic controllers (PLC) and SCADA systems, allowing device actuation, alarms, and real-time or near-real-time visual display of critical information. Notably, the invention can operate in offline or near-offline environments by relying on locally stored models and fallback routines, ensuring a secure, low-latency, and resilient solution for monitoring, diagnosing, and controlling industrial or building processes with minimal dependence on external infrastructure.

### BRIEF DESCRIPTION OF DRAWINGS

FIG. 1: System Overview Diagram (2D schematic) illustrating the major components, including data collection, transmission network, data processing layer, specialized AI tools, Agent, industrial control system & HMI, and lightweight LLM.

FIG. 2: Data Flow and Protocol Parsing (2D block diagram) showing how sensor data are parsed, normalized, and buffered before being routed to AI modules or the LLM.

FIG. 3 is a schematic diagram illustrating specialized AI modules, which can be implemented as containerized microservices or local processes.

FIG. 4 is a two-dimensional diagram illustrating the locally hosted language model, typically a quantized or optimized LLM variant (e.g., a small-scale LLaMA) that operates on edge hardware with minimal latency.

FIG. 5 is a flowchart depicting the Agent software module as it orchestrates the system's workflow in response to trigger events, such as sensor threshold breaches or user-initiated requests.

FIG. 6 is a system-level diagram showing how recommended actions from the AI modules or language model pass through the Agent module to an industrial control interface for device actuation, with a human-machine interface for operator feedback and local data storage for offline resilience.

FIG. 7 is a 2D schematic illustrating one embodiment of an AI-based irrigation control system.

FIG. 8 is a 2D block diagram depicting an embodiment of an AI-driven horticultural lighting control system based on Daily Light Integral (DLI) calculations.

### DETAILED DESCRIPTION OF THE INVENTION

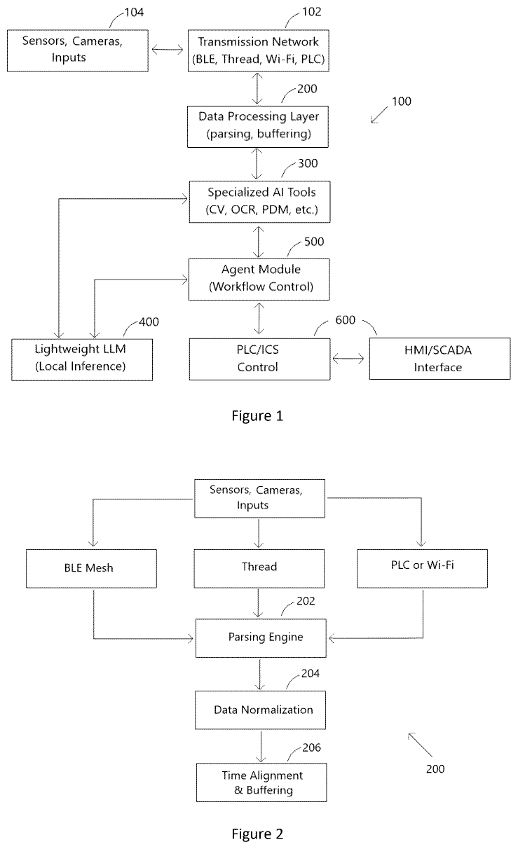

Referring to FIG. 1, in one embodiment an edge computing device 100, such as a Raspberry Pi 5 or an equivalent single-board computer, is installed on-site. This device includes a multi-protocol transmission subsystem 102 capable of managing communication over Bluetooth® Low Energy (BLE) Mesh, Thread, Wi-Fi, and Power Line Communication (PLC). Sensors and actuators 104 connect through this subsystem, thereby providing sensor readings and receiving control signals without reliance on distant network infrastructure.

With reference to FIG. 2, a data processing layer 200 is configured to parse incoming packets using protocol-specific drivers 202, which may include Open Thread, Modbus, or PLC signal parsers. The parsed data are then normalized into a uniform schema and stored temporarily in a lightweight database or message queue 204. Time alignment and buffering 206 ensure that disparate data streams are synchronized, thereby facilitating advanced correlation across different sensor types, such as vibration and temperature inputs for mechanical fault detection. This architecture supports near-real-time analysis at the edge computing device 100.

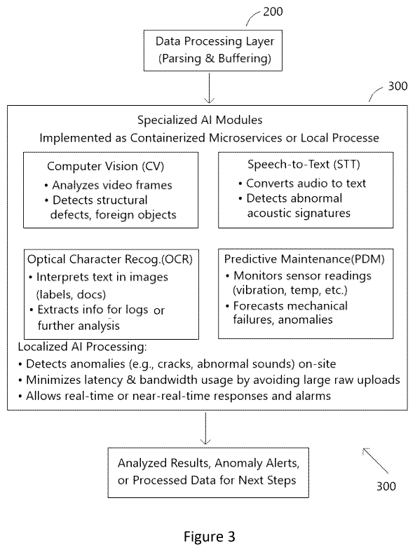

Turning to FIG. 3, the system includes a collection of specialized AI modules 300, which may be implemented as containerized microservices or local processes. These modules can perform computer vision, speech-to-text conversion, optical character recognition, and predictive maintenance analytics by processing video, audio, or numerical data directly on-site. Such localized AI processing detects anomalies, including structural defects or abnormal audio signatures, without incurring the latency or bandwidth costs of sending raw data to remote servers.

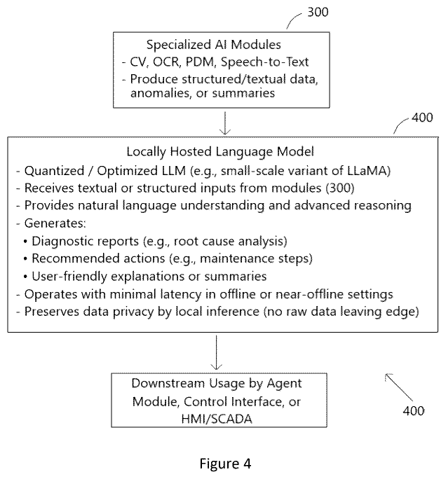

Referring next to FIG. 4, a locally hosted language model 400 provides conversational capabilities, text generation, and advanced reasoning. This model is typically a quantized or otherwise optimized version (for example, a small-scale variant of LLaMA) to accommodate hardware constraints and minimize inference latency. The language model 400 receives textual or structured inputs from the AI modules 300 and can generate diagnostic reports, recommended actions, or user-friendly explanations, all while preserving data privacy and supporting offline or near-offline operation.

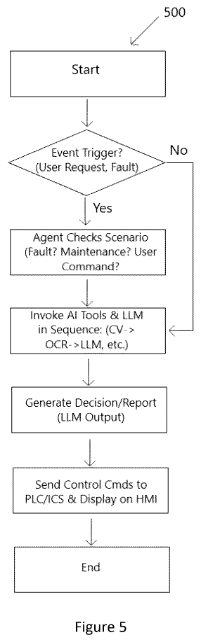

Turning now to FIG. 5, an Agent software module 500 orchestrates the overall workflow within the system. When a trigger event occurs, such as a user request submitted via a mobile application or a sensor threshold breach, the Agent 500 selects which AI modules 300 and the language model 400 are relevant for the given task. By sequencing these components, the Agent 500 enables dynamic decision-making and real-time response. For example, when vibration data exceed a predefined threshold, the Agent 500 invokes a computer vision module for immediate camera-based inspection, processes the findings through the language model 400 for summarization, and issues corresponding actions or alerts to an operator.

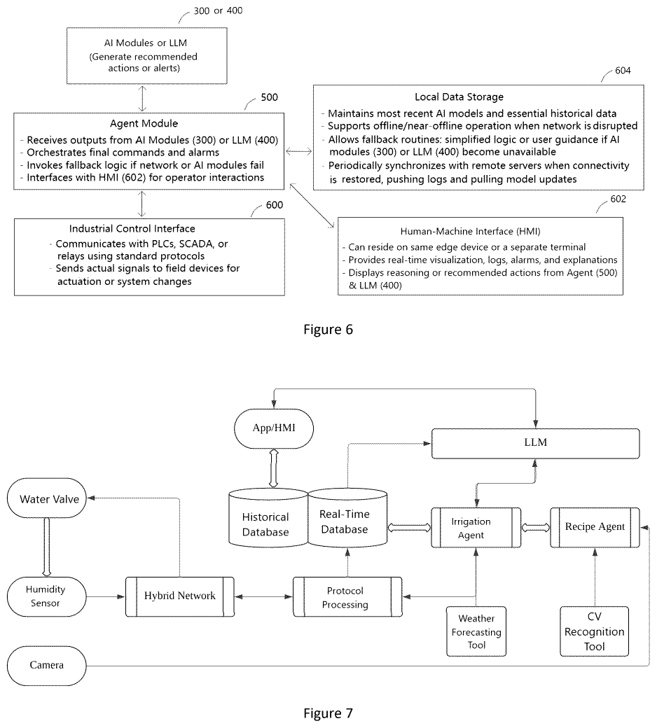

Referring to FIG. 6, the invention includes an industrial control interface 600 that communicates with field devices or actuators (e.g., PLCs, SCADA systems, or relays) using standard industrial protocols. When the AI modules 300 or the language model 400 generates recommended actions, they provide these outputs to the Agent 500, which then relays the corresponding commands through the industrial control interface 600. In this way, the Agent 500 orchestrates the final step of communicating control signals, alarms, or configuration updates to plant equipment. A human-machine interface (HMI) 602, which may reside on the same edge computing device or on a separate terminal, provides real-time data visualization, logging, and explanatory messages related to the system's decisions.

Still referring to FIG. 6, the invention accommodates unreliable network conditions and high-availability requirements through offline or near-offline modes. Local data storage 604 maintains the most recent AI models and essential historical data. If the language model 400 encounter network disruption or internal errors, the Agent 500 invokes fallback routines that include simplified rule-based logic or user-guided intervention. Periodic synchronization occurs when connectivity is restored, allowing the system to retrieve updated models or push logs to remote servers for long-term analysis and continuous model improvement. This approach ensures secure, low-latency, and resilient operation in diverse industrial or building environments.

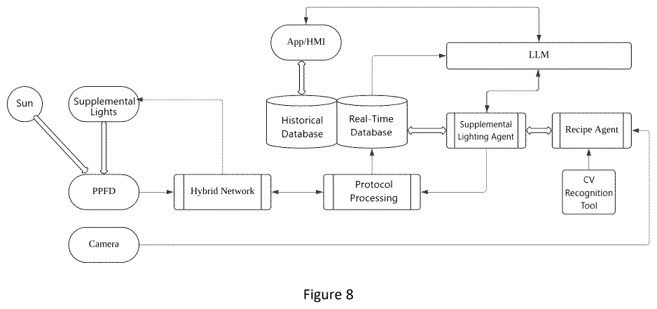

Referring to a new embodiment depicted in the corresponding FIG. 7, humidity data is collected from sensors and transmitted over a mesh network. A protocol handler then parses the incoming data and stores it in a real-time database, prompting the system to notify a language model (LLM). In response, the LLM initiates an irrigation agent, which queries a recipe agent to determine the target humidity level. If the current humidity is already within the specified range, no further action is taken. If the system has access to a networked weather forecasting tool, it can evaluate whether watering is necessary or adjust the target humidity based on forecast conditions. Once the decision to irrigate is made, the protocol handler issues a command to open the water valve, forming a closed-loop irrigation cycle. In circumstances where no humidity sensor is available, the system reverts to a manual scheduling approach. A user may direct the LLM to retrieve and display historical humidity curves, manually modify the target humidity level, or initiate watering on demand, thus providing flexibility under a variety of operating conditions.

Referring to another embodiment depicted in the accompanying FIG. 8, the greenhouse supplemental lighting system obtains Photosynthetic Photon Flux Density (PPFD) data from sensors and transfers it via a mesh network. A protocol handler then parses the data and stores it in a real-time database, after which the system notifies a language model (LLM). The LLM initiates a supplemental lighting agent. If the sun has risen and has not yet set, the system integrates PPFD over time to compute a Daily Light Integral (DLI) and thereafter concludes processing. If the Sun has set and it is within the plant's designated nighttime period, the process ends. Otherwise, the supplemental lighting agent queries a recipe agent to determine the target DLI. If the currently computed DLI is greater than or equal to the target, the system switches off the supplemental lights and terminates further action. If the computed DLI is below the target, the protocol handler issues a command to turn on the lights, thereby establishing a closed-loop supplemental lighting cycle. In circumstances where PPFD measurement is unavailable, the system operates on a manual schedule. A user may direct the LLM to retrieve and display the current DLI curve, manually adjust the target DLI, or initiate supplemental lighting on demand.

1. A system for edge-based multimodal data processing and control, comprising:
a data collection subsystem configured to acquire sensor data from a plurality of sources, the data collection subsystem operable over multiple communication protocols including at least one of BLE Mesh, Thread, Wi-Fi, and Power Line Communication;
a data processing layer coupled to the data collection subsystem, the data processing layer including a protocol parsing engine configured to convert the sensor data into a uniform format, a lightweight database or message queue for buffering and storing parsed data, and a set of AI-based tools for specialized analysis of the data, including at least one of computer vision, optical character recognition (OCR), or predictive maintenance;
a lightweight language model (LLM) stored and executed on an edge device, configured for natural language understanding, text generation, and multimodal reasoning in near-offline or offline mode;
an agent software module operably connected to the data processing layer and the LLM, the agent configured to orchestrate workflow tasks by invoking various AI-based tools, the LLM, or both, based on scenario triggers or user requests;
an industrial control interface communicatively linked to one or more control devices selected from the group consisting of PLCs, SCADA systems, or relays, the industrial control interface generating commands to actuators based on outputs from the LLM or the AI-based tools; and
a human-machine interface (HMI) for displaying alarms, diagnostic outputs, and control options.

2. The system of claim 1, wherein the agent software module is further configured to automatically switch between different workflows upon detecting a fault condition, such that computer vision analysis is triggered in response to abnormal sensor readings.

3. The system of claim 1, wherein the lightweight language model is quantized to reduce memory footprint and enable low-latency inference on resource-constrained devices.

4. The system of claim 1, wherein the data processing layer includes a real-time alignment component that merges time-stamped data from multiple sensor types, enabling advanced correlation or predictive maintenance analytics.

5. The system of claim 1, further including a retrieval-augmented generation (RAG) module for the LLM, the module configured to perform local retrieval of knowledge base documents to enhance real-time query answering and diagnostic reporting.

6. The system of claim 1, wherein the industrial control interface is configured to operate with at least one standard industrial protocol, including Modbus or OPC UA, to ensure compatibility with existing plant automation systems.

7. A method for providing local intelligence for industrial and building automation, comprising the steps of:
collecting data from a plurality of sensors via multi-protocol networks;
parsing, normalizing, and buffering the data in a data processing layer;
invoking a set of AI-based tools to perform specialized tasks including at least one of computer vision, OCR, speech processing, or predictive maintenance;
interacting with a lightweight language model (LLM) to interpret user requests or sensor data, and generate text-based analysis or recommendations;
utilizing an agent software module to coordinate and orchestrate the tasks in the previous two steps, based on scenario identifiers, scheduling needs, or sensor triggers;
communicating results to an industrial control subsystem to actuate devices or trigger alarms; and
displaying diagnostics, reports, and control options on a human-machine interface or a mobile application.

8. The method of claim 7, further comprising the step of updating the lightweight language model or AI-based tools on the edge device via a cloud connection, while maintaining offline functionality when connectivity is lost.

9. The method of claim 7, wherein the agent software module implements fault tolerance by detecting failures in AI-based tools and rerouting tasks to alternative processes or raising alerts to human operators.

10. The method of claim 7, wherein the system automatically invokes a natural language generation feature of the LLM to produce comprehensive fault reports, recommended maintenance steps, or operating instructions for on-site personnel.
